(19) United States
(12) Patent Application Publication
(10) Pub. No.: US 2003/0016901 A1
(43) Pub. Date: Jan. 23, 2003

(54) Selectively enabled delay elements for interferometers

(76) Inventor: Robert H. Cormack, Boulder, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 09/886,544

(22) Filed: Jun. 21, 2001

(51) Int. Cl. G02B 6/26

(52) U.S. Cl. 385/15; 356/477

(57) ABSTRACT

The present invention relates to interferometers with adjustable path length differences (lags). The method of adjusting the interferometer lag is by selectively enabling a plurality of different fixed path length delay elements in either or both of the interferometer arms or paths. In addition, an interferometer with a small but continuously adjustable lag may be extended to much greater lags by adding such delay elements to one or both of the interferometer's paths.

### BACKGROUND OF THE INVENTION

1. Field of the Invention

The present invention relates to interferometers with adjustable path length differences (lags). In particular, in the present invention, the method of adjusting the interferometer lag is by selectively enabling a plurality of different fixed path length delay elements in either or both of the interferometer arms or paths.

2. State of the Prior Art

Interferometers are optical devices which divide an optical input into two parts (“beams”), subject each part to a different path, then recombine the beams at the output where they interfere with each other to either increase or decrease the output intensity, depending on the difference in paths. The two paths may be physically separated, or they may be physically coincident (‘common path’ interferometers) but differentiated by polarization or the direction of propagation of the two beams.

One important use of interferometers is to determine the spectrum of the input light. Spectrum analyzers based on interferometers can achieve much higher resolution and use much lower input light levels than competing methods of spectral measurement. Because of these advantages, interferometer-based spectrometers are widely used, despite their expense, mechanical complexity and notorious sensitivity to vibration and shock.

### The use of Interferometers for Spectral Measurement

The measure of the interferometer output as the path difference or lag is changed is called the ‘Interferogram’. A given wavelength of light in the input will cause an oscillation in the interferogram that varies through one cycle each time the lag changes by one wavelength. If multiple wavelengths exist in the input, there will be corresponding multiple cycle lengths in the output. A Fourier Transform operation will identify the various cycle lengths in the interferogram, and thereby identify the wavelengths (and their amplitudes) in the input light.

It is necessary, therefore, that the interferometer be constructed such that the path difference between the two beams (the ‘lag’ of the interferometer) is adjustable. A commonly used interferometer for this purpose is the Michelson Interferometer of FIG. 1 (prior art). Input light 1 is divided into two beams by beamsplitter 2. One of the beams 3 reflects off of fixed mirror 5 and returns to the beamsplitter. The other beam 4 reflects off of movable mirror 6 and also returns to the beamsplitter. After reflecting from the mirrors, the portion of beam 3 which passes through the beamsplitter and the portion of beam 4 that reflects from the beamsplitter are combined to form output light 7. The intensity of the output light is measured by detector 8 and sent to a computer 9 where it is stored as a record of intensity vs. movable mirror position (i.e., the interferogram) and can be Fourier Transformed to find the spectrum of the input light.

The resolution of the recovered spectrum is directly proportional to the distance that the moving mirror traverses during the measurement. Roughly speaking, if two wavelengths in the input light, λ₁, λ₂ are to be distinguished from each other, then the lag must be scanned through, at least, an amount L, where L=λ₁λ₂/(λ₂−λ₁). Another way of saying this is that the number of wavelengths that divide into L must differ by at least one for λ₁, λ₂; i.e., L=nλ₂=(n+1)λ₁. This insures that the two wavelengths, λ₁, λ₂, will show up in separate bins after the Fourier Transform is applied to the interferogram. For example, to resolve wavelengths at 700.0 nm and 700.1 nm, the lag would have to change by at least,

L=700*700.1/(700.1−700)=4,900,700 nm≡5 mm

In typical instruments, the mirror can move from a fraction of a millimeter to several centimeters total translation distance, depending on the wavelength being measured and the desired resolution. While the moving mirror is being translated, it must maintain its orientation perpendicular to the beam propagation direction to a very high degree of accuracy. In addition, the position of the mirror (and hence the current lag of the interferometer) must be known to a small fraction of the wavelength of light being measured. Failure to maintain these tight mechanical tolerances will result in a low contrast and distorted interferogram, and any attempt to calculate a spectrum from it will therefore be compromised.

### Problems with Current Interferometer Technology

Because of the requirement for very high mechanical precision, spectrum analysis instruments based on interferometers are very costly, often need to be re-calibrated after they are subject to mechanical shock or vibration (even, sometimes, from simply being moved) and can rarely be used as portable field instruments. The expense and delicacy of these instruments severely limits their applications and usefulness, despite the many advantages that they have over competing technologies (see, for example, P. Hariharan, “Optical Interferometry”, Academic Press, 1985).

To be part of a useful field instrument rather than just a laboratory device, interferometers must achieve the conflicting requirements of high mechanical precision with stability, ruggedness, and repeatability. One way to deal with this problem is simply to make the interferometer mechanical structure so massive and rigid that environmental effects are minimized. This, however, results in large, expensive devices. Another common solution is to use an auxiliary laser interferometer to track the position of the moving mirror. This eases the difficult-to-achieve need for extreme linearity in the mirror-drive mechanism, but adds considerable expense and increases package size. In order to address these problems at a more economical and compact level, a number of modifications to the basic interferometer design have been proposed:

### Spatial Output Interferometers

Interferometers can be made so as to project an image of the interferogram over a fixed set of lags, without the necessity of moving parts. One way of doing this with a Michelson interferometer is to keep both mirrors fixed, but tilt one of them so that light that strikes one side of the tilted mirror has a different path length (and hence, different lag) than light striking the other. If the optics are such that the tilted mirror is imaged at the output, then a portion of the interferogram, seen as a set of parallel bands, or fringes, will appear. In this way, the interferogram can be produced and detected over a limited set of lags without the necessity of moving any of the optics. This technique is limited to relatively small ranges, however, since the tilt must be small compared to the overall size of the mirror in order to keep the light passing correctly through the instrument.

Froggat and Erdogan (“All Fiber Wavemeter and Fourier transform Spectrometer,” Optics Letters, Vol. 24, No. 14, July 1999) describe a spatial output interferometer where optical fibers contain the optical paths and light is coupled out of the output fiber gradually over a long range. While this technique is not intrinsically limited to small lags, the signal available decreases with greater lag ranges, since the available output light must be spread out over all lags.

Prunet, et al. (“Exact calculation of the optical path difference and description of a new birefringent interferometer,” Optical Engineering, Vol. 38, June 1999) describe a spatial output interferometer made with birefringent prisms; and Dierkin (U.S. Pat. No. 5,541,728) describes one made from a collection of glass prisms. Both of these instruments have some advantages over moving-mirror Michelson interferometers, namely they are much more stable and simple to build, but they are limited to small lag ranges.

While these techniques allow less expensive, stable interferometers, they give up one of the important advantages of the basic scanning interferometer over other spectral measurement methods—namely, its superior performance at low light levels. For example, consider that a spatial output interferometer produces an image of a portion of the interferogram, and it is desired to detect that image at 100 points with a linear CCD array. Then each point on the interferogram is detected with only 1/100 of the input light. In the Michelson interferometer of FIG. 1 (prior art), however, each point on the interferogram is detected using all of the available light. This large signal advantage of a scanning interferometer is known as the multiplex advantage. For the example above, the multiplex advantage (also called the Fellgett advantage) in the scanning interferometer results in a signal-to-noise ratio (SNR) that is ten times (square root of 100) the SNR of the spatial output interferometer.

The same multiplex advantage applies to the interferometer when compared with a grating or prism dispersive spectrometer—for the dispersive instrument each portion of the spectrum is detected using only a fraction of the total light, whereas the interferometer's detector always looks at all of the available light. To increase resolution, the dispersive instrument must spread the spectrum out even more, resulting in a progressively worse SNR compared to the interferometer. Increasing the spectral resolution of the interferometer is accomplished simply by detecting the interferogram over a wider lag range—there is no signal penalty involved. This is why interferometers are the method of choice for spectrum analysis when the available input light is low or very high resolutions are required. To some degree, spatial output interferometers forfeit part of this advantage to achieve greater stability.

### Multiple Parallel-Channel Interferometers

Another way to avoid long mirror movements is to divide the input light into several parts and analyze each part with a separate interferometer, or a separate channel of one interferometer, in such a way that the separate interferometers or separate channels sample adjacent but non-overlapping segments of the interferogram:

Li (U.S. Pat. No. 6,014,214) describes the use of separate, parallel interferometers for use in Optical Coherence Tomography.

Chase and Metz (U.S. Pat. No. 5,561,521) describe a Michelson interferometer used for two wave bands simultaneously by means of dichroic mirrors.

Ryan (U.S. Pat. No. 5,422,721) describes a Michelson interferometer in which the fixed mirror is divided into several parts, each with a different path length from the beamsplitter. Each mirror part directs light to a different detector, whereas the moving mirror is not divided and directs light to all detectors.

By reducing the range of motion of the moving mirror, the above techniques reduce the expense and difficulty to maintain the required mechanical precision. Although some of the multiplex advantage is lost, it is only to the extent of the number of parallel channels used, rather than the number of readings taken of the entire interferogram, as in the spatial-output designs. While these multiple-channel designs represent a useful tradeoff between the multiplex advantage and the mechanical difficulties of long mirror movements, they suffer the cost of increased mechanical complexity and alignment requirements. Also, they are still sensitive to vibration and shock as any moving-mirror interferometer.

### Non-Mechanical Path-Length Adjustment Methods—Liquid Crystals

A liquid crystal (LC) cell, properly constructed and used in the Electrically Controllable Birefringence (ECB) mode, can be used as an electrically controllable path length element. For light of the correct polarization, the cell's index of refraction (and hence its optical thickness) can be varied over a small range by an electrical signal. This has lead to a number of proposals (e.g. U.S. Pat. No. 4,394,069) to use LC cells in interferometers as means to non-mechanically adjust the path lengths and lags. One of these proposals (U.S. Pat. No. 5,600,440) uses grids of LC cells (“Spatial Light Modulators”—SLMs) to achieve simultaneously the advantages of non-mechanical lag adjustment and parallel channels in a Michelson interferometer.

While the non-mechanical aspect of LC path adjustment is a great improvement over the moving-mirror interferometer, the fact is that practical LC cells are unable to change the effective path length by more than a few microns. This is insufficient for most practical interferometer applications.

### Unique Interferometers and Adjustment Methods

There have been a number of pure mechanical attempts to design devices for changing the lag of an interferometer that have some advantages over the usual moving-mirror Michelson interferometer:

Bertram, et al. (U.S. Pat. No. 5,537,208), have designed a Michelson-type interferometer in which two co-rotating mirrors adjust the path length, rather than a linearly moving mirror.

Solomon (U.S. Pat. No. 5,196,902) has designed a replacement for the moving mirror, which produces a path-length change many times larger than the physical movement of the mirror.

Gelikonov, et al. (U.S. Pat. No. 5,867,268), propose an optical fiber interferometer where a coil of fiber in one arm is stretched by piezoelectric actuators in order to change the path length.

While the above proposals have merit, they also trade off known fabrication problems with moving-mirror interferometers for different but unknown mechanical characteristics of these unique designs, such as accuracy, repeatability, and long-term stability.

There continue to be problems with the cost, size, and stability of interferometers capable of scanning the interferogram out to large lags.

### Summary of the Problem with Current Interferometers

While interferometers with small lag ranges can be made relatively mechanically robust, or even made without moving parts at all, these interferometers are not capable of the high-resolution spectrometry where interferometric instruments have excelled. Interferometers with large lag ranges, however, currently all use some form of mechanical movement to adjust the lag. This requires extremely precise and rigid mechanisms, which cause the interferometer to be expensive and/or sensitive to vibration and susceptible to loss of alignment and calibration.

### SUMMARY OF THE INVENTION

The present invention utilizes conventional means of switching light to selectively enable a plurality of different fixed path length delay elements in either or both of the interferometer arms or paths. For example, some embodiments switch a plurality of different, but fixed, path lengths into one or both arms of an interferometer such that the interferometer can sample a number of discrete points in the interferogram over any desired range of lags without any moving mirrors.

The present invention relates to interferometers with adjustable path length differences (lags). In particular, in the present invention, the method of adjusting the interferometer lag is by selectively enabling a plurality of different fixed path length delay elements in either or both of the interferometer arms or paths. The present invention also details various methods of implementing the delay elements. In addition, an interferometer with a small but continuously adjustable lag may be extended to much greater lags by adding such selective delay elements to one or both of the interferometer's paths. By these means, adjustable interferometers can be constructed which are stable and highly resistant to vibrations and mechanical shocks. The unprecedented stability of these interferometers enable a number of applications, including portable and highly accurate spectrometers, portable imaging spectrometers, non-invasive biological sensors, portable pollution sensors and process control equipment.

In many of the possible embodiments, the switching can also be done without any moving parts at all. Both fixed light delay elements and light-switching methods can be made very stable; therefore the interferometer inherits this stability, while still being adjustable over an unlimited (in principle) range of lags.

A method of choosing and arranging such selectively enabled delay elements allows the maximum number of different lags to be selected with the minimum number of delay elements and light switches. In particular, the delay elements can be arranged serially, and chosen in a binary sequence. For example, the set of selective delays: (Γ, 2Γ, 4Γ, . . . 2ⁿΓ) (where Γ represents the smallest change of lag desired), can be used in combinations to achieve the complete set of lags: (0, Γ, 2Γ, 3Γ, 4Γ, . . . (2ⁿ⁺¹−1)Γ).

A plurality of selective delays may be added to an interferometer that is capable of detecting a small portion of the interferogram (e.g., an interferometer with a small adjustable lag range; or a spatial-output interferometer). Then, the combination of the small adjustable range plus the plurality of selective delays allows sampling the interferogram continuously over a very wide lag range. Since fixed selective delay elements can be made very stable without undue cost or complexity; and furthermore light switching methods (especially those without moving parts) can be very stable and repeatable; and also small-range interferometers can be very stable and may not even need any moving parts; therefore the configuration of a small range interferometer plus a plurality of selectively enabled delay elements is a uniquely stable and simple way of building an interferometer which can sample the interferogram continuously over very large lag ranges.

Several embodiments of selectively enabled delay element interferometers produce stable, inexpensive interferometers with large adjustable lag ranges.

Various embodiments include:

Optical fibers of diverse lengths switched into or out of an interferometer path using known fiber-switching methods.

Birefringent plates with polarization rotators that determine which index of refraction of the plate affects the input beam, and hence the optical path length through the plate.

Free-space optical delay elements switched using polarization rotators and polarizing beamsplitters.

Switchable mirrors, using polarization sensitive reflectors, such as are made by 3M Corp in combination with polarization rotators.

Switchable lenses, holograms, and prisms using Liquid Crystal methods and devices such as are produced by DigiLens Corp.

Discrete optical delay elements which are selected by switching the input beam with Acousto-Optic devices or by controllable mirrors such as galvanometer-driven mirrors.

In all of the above embodiments, the key is to switch between static light delay elements which cause selective delays. Static (constant length) delay elements can be made very stable without undue cost or complexity. Likewise, light-switching means may also be very stable and repeatable. Thus, regardless of how large the range of lags producible by the fixed delay elements and combinations thereof, the interferometer remains stable and only as sensitive to drift, vibration, and shock as the mechanism of each delay element. Some embodiments, using birefringent plates in particular, are almost completely insensitive to such disturbances.

Another embodiment of a selectively enabled delay element interferometer uses birefringent plates and polarization rotators in a common-path interferometer design. In this embodiment, the two beams both traverse the same rotators and birefringent elements, but are differentiated by having orthogonal polarizations. In this embodiment, all changes in the interferometer's lag occur entirely within the birefringent plates: Changes in spacing between the plates, relative alignment of the plates, and in fact any changes in the air paths between plates have no effect on the lag. This interferometer is, therefore, virtually completely immune to vibration and mechanical shock, regardless of how far the lag range is extended by the incorporation of additional birefringent elements and polarization rotators.

A embodiment uses a common-path, birefringent plate, switched-path interferometer (as described above) constructed using known methods to make both the polarization rotators and the birefringent elements have a constant effect over a wide range of light input angles. Thus, this embodiment does not require that the light within the instrument be substantially collimated (or collimatable), in contrast to all other spectroscopic instruments, both interferometric and dispersive. This feature provides a substantial signal advantage over other instruments for diverse uses, including the measuring of extended, diffuse sources (which is an important feature for non-invasive spectral measurements in the human body, or in scattering fluids in general). In addition, the ability to use non-collimated light combined with compactness and a high degree of mechanical stability allows hyper-spectral imaging to be achieved simply by imaging through such interferometer (at a succession of lags) using an ordinary CCD camera.

A common-path, birefringent plate, switched-path interferometer (as described above) can alternately be constructed using parallel arrays of polarization rotators based on Liquid-Crystal Spatial Light Modulators (SLMs) and using an array of detectors at the output. This embodiment allows very rapid parallel detection of the interferogram (thus sacrificing the multiplex advantage) while retaining the advantage of high through-put for extended sources described above. Further advantageous uses of this embodiment are as a programmable wavefront generator useful for generating reference wavefronts for interferometric inspection of non-symmetrical or otherwise unusual optics or surfaces. In a variation of this embodiment, the various output beams (one per pixel of the SLMs) are combined into a single beam, allowing the switched-path interferometer to function as a programmable filter capable of producing an arbitrary bandpass function.

A method according to this invention utilizes the unique properties of switched-path interferometers—particularly the ability to reproduce a given set of widely spaced lags with a high degree of accuracy—to enable the use of unique data analysis algorithms (involving the taking of aliased and ‘dithered’ data sparsely throughout the interferogram) that can generate a high-resolution representation of a region-of-interest of the optical spectrum using only a small fraction of the interferogram data required by the usual moving-mirror (Michelson-type) interferometers.

### BRIEF DESCRIPTION OF THE DRAWINGS

FIG. 1 (Prior Art) is a diagram of an adjustable-lag Michelson interferometer.

FIG. 2 is a functional block diagram of an adjustable lag interferometer utilizing selectively enabled delay elements in one or both paths, according to the present invention.

FIG. 3a is block diagram showing the use of a polarization rotator and a birefringent plate as a selective delay element in the interferometer of FIG. 2.

FIG. 3b is a block diagram showing a (common-path) embodiment of the interferometer of FIG. 2, using the selective delay elements of FIG. 3a.

FIG. 4a is a block diagram showing a selectively enabled delay element using free-space paths and polarizing beamsplitters.

FIG. 4b is a block diagram showing a implementation of the delay elements of FIG. 4a using optical fibers, fiber switches, and fiber combiners.

FIG. 5a is a block diagram showing the implementation of a selectively enabled delay element using a switchable mirror.

FIG. 5b is a block diagram showing an implementation of an adjustable lag interferometer using the switchable mirror selective delay elements of FIG. 5a.

FIG. 6a is a block diagram showing an adjustable lag interferometer using a beam-scanning means to create a plurality of selective delays.

FIG. 6b is a block diagram showing an angle-scanned beam converted to a telecentric beam for use in FIG. 6a.

FIG. 6c is a block diagram showing the telecentric scanner of in FIG. 6b used to construct an adjustable lag interferometer having a plurality of selectively enabled delays according to the present invention.

FIG. 7 is a block diagram showing another embodiment of a scanner-based, adjustable lag interferometer having a plurality of selectively enabled delays according to the present invention.

FIG. 8 is a block diagram showing the addition of adjustable beam-shaping optics and a special target block to the interferometer of FIG. 7.

FIG. 9a is a block diagram showing a birefringent interferometer, similar to that of FIG. 3b, where the polarization rotators are replaced with Spatial Light Modulators (SLMs) set up to act as pixilated polarization rotators.

FIG. 9b shows a detection scheme for using the device of FIG. 9a as a multiple parallel path interferometer.

FIG. 9b shows a scheme for using the device of FIG. 9a as a FIR filter.

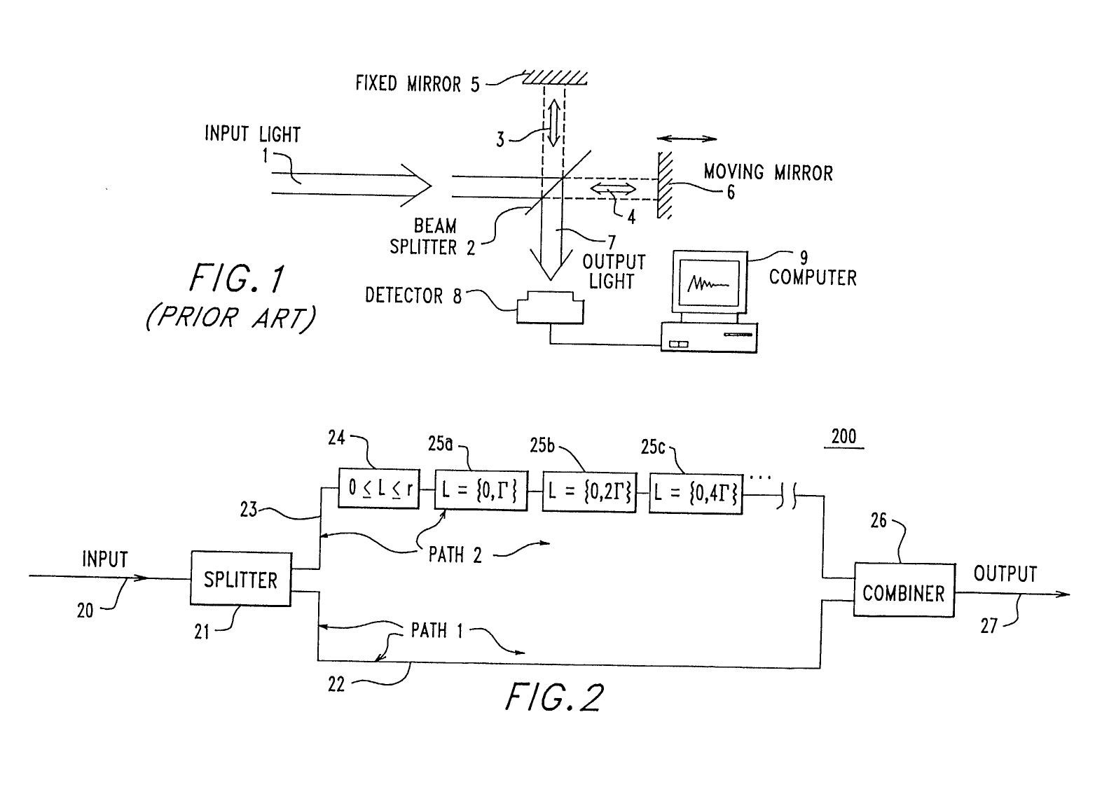

### DETAILED DESCRIPTION OF THE PREFERRED EMBODIMENTS

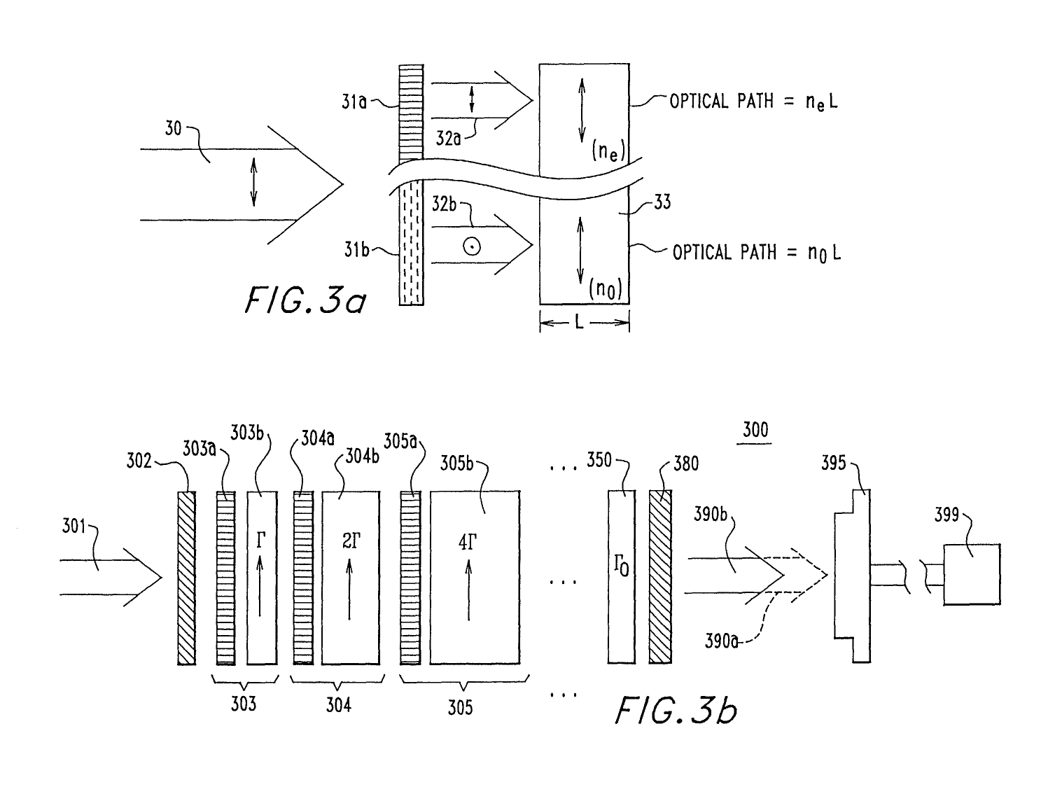

A functional block diagram of an adjustable lag interferometer utilizing a plurality of selectively enabled delay elements in one or both paths according to the present invention is shown in FIG. 2. The interferometer directs the input light, 20, to a splitter, 21. The function of the splitter is to divide the input light into two parts which traverse two separate paths; a first path, 22, and a second path, 23. While the first path is shown as fixed here some of the selectively enabled delays may be incorporated into this path, as shown in FIG. 3. The second path contains a number of elements, 25a, b, c, . . . , each of whose path length, L, can be switched between two values, for example 0 and nΓ.

Similarly, while the two paths are shown as physically separate, some embodiments of the present inventions are common path interferometers, where the optical path of the two beams varies, but the physical path is common.

In general, each of these elements 25 has a minimum path length that is different than zero, say P. Then each element 25 in path 23 switches between P and P+nΓ. The sum of all the minimum paths in the second path, 23, can be compensated for by adding a fixed length to the first path, 22, equal to said sum (and vice versa).

Optionally, the first or second path can also include a variable path device, 24, which is shown as being adjustable to any value between 0 and Γ. While not strictly necessary for the operation of the switched-path interferometer, the adjustable-path unit, 24, may be convenient or economical in certain embodiments, particularly if the adjustment range is small enough to be constructed ruggedly and inexpensively. It can be a mechanically adjustable mechanism, an adjustable liquid crystal cell, or one of the spatial-output interferometer mechanisms described in the prior art.

After traversing the two paths, the light enters a combiner 26, and is combined into a single output 27. This output would, in usual applications, be measured by a detector (not shown) and recorded as a function of the interferometer's lag.

The lag of the interferometer is set by selectively enabling some number of the switchable delay elements, 25. For example, if none of these elements are switched on, then the lag is adjustable between 0 and Γ by the adjustable element, 24. If the first switchable delay element, 25a, is set to a lag of Γ, then the adjustable element can change the lag from Γ to 2Γ. If only the second switchable delay element, 25b, is set, then the lag range is 2Γ to 3Γ.

If both delay elements 25a and 25b are set, then the range is 3Γ to 4Γ, and so on. Table 1, below, illustrates specifically how this is achieved:

TABLE 1
Switched Path Interferometer Operation

| Switched Element #: | 25a | 25b | 25c | 25d |
|---|---|---|---|---|
| Lag States of Switchable | 0, Γ | 0, 2Γ | 0, 3Γ | 0, 4Γ |
| Element | | | | |

| Configuration # | Element Lag States: | | | | Total Lag: |
|---|---|---|---|---|---|
| 1 | 0 | 0 | 0 | 0 | 0 |
| 2 | 1Γ | 0 | 0 | 0 | 1Γ |
| 3 | 0 | 2Γ | 0 | 0 | 2Γ |
| 4 | 1Γ | 2Γ | 0 | 0 | 3Γ |
| 5 | 0 | 0 | 4Γ | 0 | 4Γ |
| 6 | 1Γ | 0 | 4Γ | 0 | 5Γ |
| 7 | 0 | 2Γ | 4Γ | 0 | 6Γ |
| 8 | 1Γ | 2Γ | 4Γ | 0 | 7Γ |
| 9 | 0 | 0 | 0 | 8Γ | 8Γ |
| 10 | 1Γ | 0 | 0 | 8Γ | 9Γ |
| 11 | 0 | 2Γ | 0 | 8Γ | 10Γ |
| 12 | 1Γ | 2Γ | 0 | 8Γ | 11Γ |
| 13 | 0 | 0 | 4Γ | 8Γ | 12Γ |
| 14 | 1Γ | 0 | 4Γ | 8Γ | 13Γ |
| 15 | 0 | 2Γ | 4Γ | 8Γ | 14Γ |
| 16 | 1Γ | 2Γ | 4Γ | 8Γ | 15Γ |

Since all of the selectively enabled delay elements 25 in the interferometer are fixed-length elements, these elements can be made very stable. Since there is, in principle, no limit to the number of selectively enabled delay elements that can be included in the interferometer, the range of lags that can be addressed by switching fixed paths is also unlimited. In fact, with the selectively enabled delay elements arranged in a binary progression (1, 2, 4, 8, . . . ) as shown, doubling the lag range of the interferometer is achieved simply by adding the next selectively enabled delay element in the progression. Thus, an interferometer built according to this invention, as shown in FIG. 2, can measure the interferogram at a discrete set of lags (at a spacing of Γ) over an arbitrarily large lag range using only fixed paths. Optionally, by using a small and robust adjustable path device 24 in combination with selectively enabled delay elements 25 a large, continuous range of lags can be measured.

A specific embodiment of the adjustable lag interferometer of FIG. 2 is illustrated in FIG. 3a and FIG. 3b. FIG. 3a shows a switchable polarization rotator, 31, and a plate of birefringent optical material, 33, combined to achieve switching between two static optical path lengths. In this figure, input light 30 is linearly polarized in the plane of the drawing (as shown by the vertical, two-headed arrow). In the upper half of FIG. 3a, polarization rotator 31a is set to pass the incident polarization unchanged, as shown by arrow 32a. In this polarization state, the polarization vector of the light is aligned with the optical axis of the birefringent plate, 33, as shown by the arrow within the plate. For this instance, the effective index of refraction of the plate is the extraordinary index, nₑ, and the optical path length of the plate is nₑ L, where L is the thickness of the plate, as shown. In the other state of the switchable path element, polarization rotator 31b is set to rotate the input light polarization by 90°, as shown in the bottom half of the figure. Rotated light 32b then has its polarization vector perpendicular to the optical axis of birefringent plate 33 and so the effective index of refraction is the ordinary index, nₒ. In this case the optical path length of the plate is nₒ L.

The difference between the path lengths for the two states shown in FIG. 3a is:

Γ=nₑL−n₀L=(nₑ−n₀)L=ΔnL, where Δn=nₑ−n₀.

Values of Δn for commonly used optical materials range from 0.009 for quartz, 0.17 for calcite, and 0.3 for rutile (TiO₂); up to extreme values such as 0.68 for Hg₂CL₂ (useful in the visible to IR) and 0.82 for Selenium (useful only in IR). Also, switchable polarization rotators can be conveniently made using liquid crystal cells of appropriate design. Thus, switchable path elements based on FIG. 3a can be easily made to cover a very wide range of lags (nanometers to many millimeters), in any desired part of the optical spectrum, and operate using no moving parts.

To be completely independent of downstream optics, the selective delay element of FIG. 3a would need to have a second polarization rotator after the birefringent plate, to restore the polarization to its initial value. This can be dispensed with in practical devices, however, as the computer operating a series of such selective delay elements can easily take into account the current state of all upstream switches when deciding how to set a given switch.

FIG. 3b illustrates a complete, common-path interferometer that uses the selective delay elements of FIG. 3a. FIG. 3b is functionally equivalent to the embodiment shown in FIG. 2, but has the additional advantage of being a common path device. Thus, the inherent difficulties of matching two physically different optical paths, and keeping the paths matched under varying conditions, is avoided.

Unpolarized input light, 301, is polarized at 45° to the plane of the drawing by the input polarizer, 302. Light at this polarization can be considered to consist of two, equal, correlated, mutually coherent beams; one polarized in the plane of the drawing, and one polarized perpendicular to said plane. These constitute the two beams in this common-path interferometer, and the subsequent optical elements are designed to operate differently on each beam. Following the establishment of the two beams by the polarizer, the light enters a series of selective delay optical elements (303, 304, 305, . . . ) constructed from polarization rotators (303a, 304a, 304b, . . . ) and birefringent plates (303b, 304b, 305b, . . . ) as shown in FIG. 3a. Each of these elements delays one of the two beams with respect to the other by n Γ, where n=1, 2, 4, etc. and chosen base upon the desired characteristics of a particular switch. Which beam gets delayed depends on both the setting of the polarization rotator just before the given birefringent plate, and also on the settings of the rotators upstream, as discussed above.

Optionally, the interferometer can also have an adjustable delay element and/or a bias delay element, 350. This element can serve a number of useful purposes: if it is adjustable over the range 0-Γ, it will allow a continuous sampling of the interferogram as well as allowing the interferometer (with selective delay magnitudes as shown) to reach zero lag. A larger bias delay (possibly combined with an adjustable delay) would permit the interferometer to sample the interferogram on one side of zero lag only, for a lag range twice as large as would be possible with a symmetrical sampling.

After passing through selective delay elements 303, 304, 305, . . . , a portion of each of the two beams are combined into one beam by output polarizer 380, which is set to the same polarization angle as input polarizer 302. Hence, output light 390 consists of a copy of input light 390a plus a delayed copy of said light, 390b, the delay being set by the particular state of selective delay elements 303, 304, 305, . . . and optional variable delay element 350. The recombined output beams interfere at and are detected by light detector element 395. The output of detector 395 is sent to computer 399, which records the value as a function of the interferometer lag.

Although not shown in the drawing, computer 399 also preferably controls the various settings of the polarization-rotating elements 303a, 304a, 305a, . . . , and optional variable delay element 350. Each selective delay element 303, 304, 305, . . . delays both beams (which are differentiated by having orthogonal polarizations) at once, one beam being delayed by nₑL, while the other beam simultaneously is delayed by nₒL. Thus, the total change between the two beam's path lengths upon switching is:

(nₑ−n₀)L=ΔnL=Γ,

where nₑ−nₒ is the difference in optical path lengths through the element for the two orthogonal polarizations of light. Thus, for this common-path interferometer, the selectively enabled delay elements have a somewhat different effect on the total interferometer lag, as shown in Table 2:

TABLE 2
Switched, Common-Path Interferometer Operation

| Switched Element # | 303 | 304 | 305 | |
|---|---|---|---|---|
| Lag States of | ±Γ | ±2 Γ | ±4 Γ | |
| Element | | | | |
| | Switched Element | | | Total |
| Configuration # | Lag States: | | | Lag: |
| 1 | −1 Γ | −2 Γ | −4 Γ | −7 Γ |
| 2 | +1 Γ | −2 Γ | −4 Γ | −5 Γ |
| 3 | −1 Γ | +2 Γ | −4 Γ | −3 Γ |
| 4 | +1 Γ | +2 Γ | −4 Γ | −1 Γ |
| 5 | −1 Γ | −2 Γ | +4 Γ | 1 Γ |
| 6 | +1 Γ | −2 Γ | +4 Γ | 3 Γ |
| 7 | −1 Γ | +2 Γ | +4 Γ | 5 Γ |
| 8 | +1 Γ | +2 Γ | +4 Γ | 7 Γ |

As can be seen from Table 2, the total lag is symmetrical about zero. Since the interferogram is a symmetric function, it is only necessary to sample it on one side of zero (either the positive or negative side). In order to accomplish this, the bias element, 350, may be set equal to the most positive total lag. If a bias of 7Γ is added to the values in the table for example, then the total lag then is selected from the set: {0Γ, 2Γ, 4Γ, 6Γ, 8Γ, 10Γ, 12Γ, 14Γ}. Thus, by proper choice of the bias element, 350, and the minimum lag, Γ, any uniformly-spaced set of 2^{N} lags may be sampled by the interferometer, where N is the number of switchable path elements.

The interferometer shown in FIG. 3b has a number of unique and useful properties:

Stability: All of the path delays between the two beams take place within the birefringent plates—the air gaps (if any) between elements have no effect on the lag. Hence, the interferometer is completely insensitive to longitudinal positioning of the elements. Also, the birefringent plates may be constructed to be insensitive to the incident angle of light, either by using appropriate biaxial birefringent materials or by constructing each plate from a number of uniaxial plates at certain angles to each other, according to known art. Thus, it is possible to build the interferometer of FIG. 3b such that it is essentially insensitive to all alignment variations, with the exception of rotation, between elements.

Wide Field of View: Certain kinds of birefringent plates or combination of plates (described above) have a retardance that is nearly constant for a wide range of incident light angles. If such plates are used in the construction of the interferometer shown in FIG. 3b, then the interferometer will be able to use light at wide angles (up to 30° from normal incidence). This will allow the interferometer to use light from extended sources such as occurs in trying to measure transmission spectra through turbid materials. Normal interferometers and spectrometers must use substantially collimated light, so cannot use more than a small fraction of the light from such sources. This significantly increased throughput is a unique advantage of this embodiment of the invention, and will be a significant advantage for tasks such as non-invasive spectroscopy of the human body (to measure glucose and blood gases, for example) and for non-contact measurement of many materials in industrial processes.

Hyper-Spectral Imaging: The properties of stability and wide field of view described above, combined with the expected compactness of this interferometer (when constructed for modest lag ranges of several millimeters) allow one to create hyper-spectral image sets (image cubes) by simply attaching an interferometer of sufficient aperture to the lens of a CCD camera and taking a series of images of a given scene using a range of interferometer lags. The sequence formed by each pixel in the sequence of images is then the interferogram characteristic of the spectrum of the pixel. Simply Fourier transforming each such sequence produces the hyper-spectral image data cube. While it is theoretically possible to image through any Michelson interferometer with a camera, such a combination would have a very restricted field of view (because of the requirement for collimated light) and would likely be too fragile and cumbersome for field use.

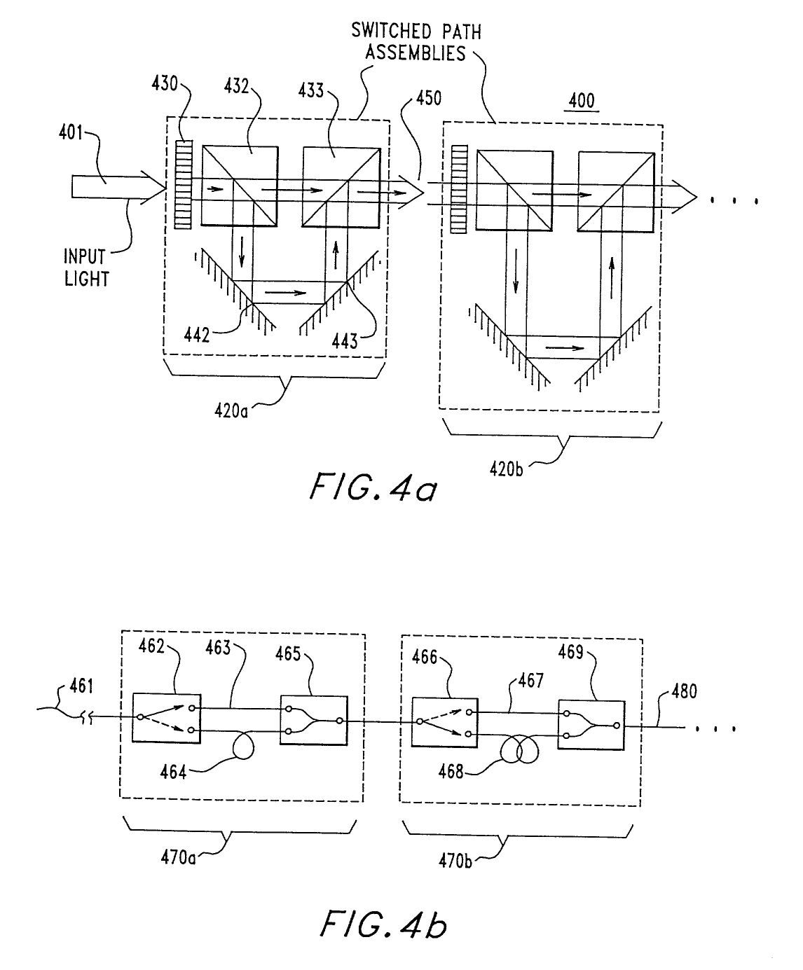

FIG. 4a illustrates how selectively enabled delay elements can be implemented for free-space propagating beams. Input beam 401 is linearly polarized. The diagram shows two complete selectively enabled delay assemblies, 420a and 420b. Each assembly is capable of switching between two paths implementing delays of different length.

The operation of the first assembly is as follows: Input beam 401 first encounters switchable polarization rotator 430. If rotator 430 is set to pass the light unchanged, the beam takes the short route straight through polarization beamsplitters 432 and 433. If, on the other hand, the polarization of the light is changed by rotator 430, then the beam will take the long route—reflecting first from beamsplitter 432, then from mirrors 442 and 443, and finally from beamsplitter 433 before exiting, 450. The same two possibilities are encountered in the second selectively enabled delay assembly, 420b, except that the long path is shown as twice as long as the long path in 420a.

Obviously, any number of such assemblies may be arranged sequentially. Also, as would occur to someone skilled in the art, alternate methods of switching free space beams would work equally as well—in particular, one could double the light throughput by using the method taught by Kuang-Yi, et al. to switch unpolarized light using polarizing beamsplitters, polarization rotators, and birefringent materials.

Another embodiment using standard optical fiber technology is shown in FIG. 4b. Shown are two selective delay assemblies 470a and 470b, such as might be placed into one or both arms of a fiber optic interferometer. The operation of the first assembly is as follows: Input light 461 enters through an optical fiber and reaches fiber optic switch 462. This is any device, as known in the art, capable of switching the signal from the input fiber to either of two output fibers, 463 or 464. These two output fibers differ only in their length, with 464 shown as the longer of the two. Regardless of which path the light takes (according to the setting of switch 462), the light arrives at fiber combiner 465. Here, the light is routed onto a single output fiber which conveys the light to the next selectively enabled delay assembly, 470b.

Here, the light is again switched between two possible paths, 467 and 468, by fiber switch 466. The longer of the two paths, 468, is preferably twice as long as the longer path, 464, in the previous selectively enabled delay assembly.

Both kinds of selectively enabled delay assemblies detailed in FIG. 4a and FIG. 4b can be used to implement an adjustable lag interferometer as shown in FIG. 2. Such an interferometer can be designed to achieve an arbitrary number of different lags over an arbitrary lag range. With the fiber embodiment of FIG. 4b in particular, the resulting interferometer is completely immune from the problems of mechanical alignment and stability that plague most other interferometer designs, regardless of how large a lag range that the interferometer was designed for.

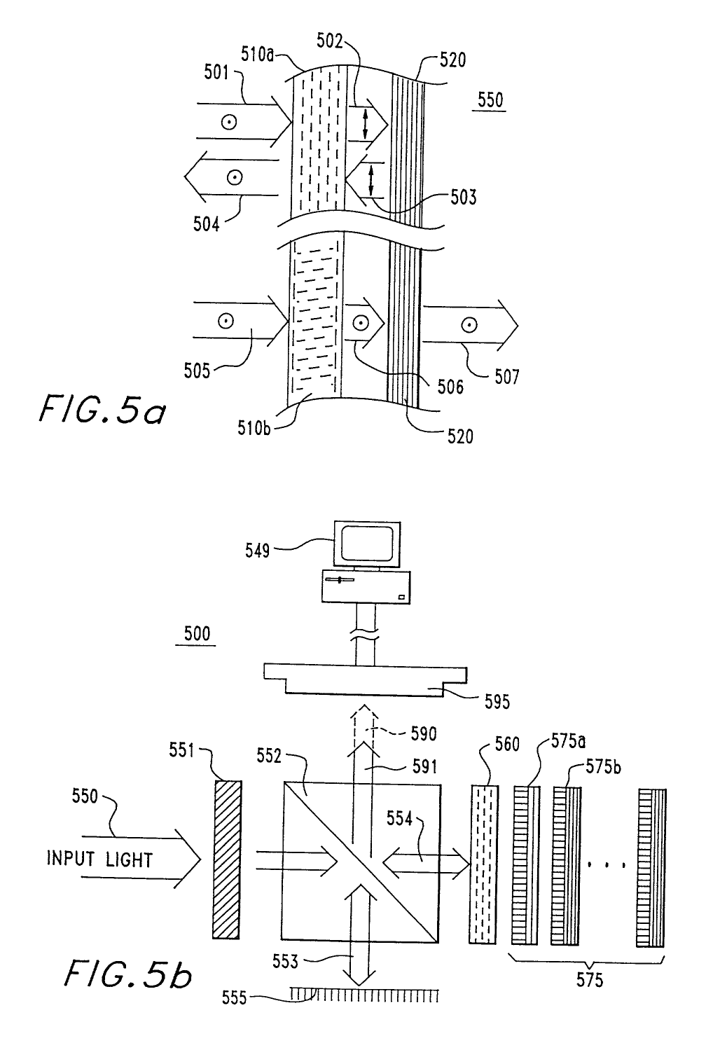

FIG. 5a and FIG. 5b illustrate a different kind of selectively enabled delay assembly and resultant interferometer based on switchable mirrors. While physically, this interferometer is considerably different from the preceding embodiments, it uses the same principle of switching between different static path lengths (equivalent to the selective delay elements of FIG. 2) to achieve the majority of the lag adjustment.

FIG. 5a shows the details of a switchable mirror. The switchable mirror assembly consists of two components: switchable polarization rotator 510, and polarization-selective mirror 520. Polarization-selective mirror 520 is a device which reflects one polarization of light, while transmitting the other. These conventional devices are made by, for example, 3M Corporation, which refers to them as “Giant Birefringent Optics” devices. They are made of hundreds of alternating layers of two birefringent materials. For one polarization orientation, the effective indices of refraction are different for alternate layers and the device acts as an interference mirror. For the orthogonal polarization, the effective indices of adjacent layers are the same, and no interference effects occur, allowing the light to pass through.

The operation of the switchable mirror is as follows: In the top half of FIG. 5a, switchable polarization rotator 510a is set so as to rotate incoming light 501. The light passing through the rotator, 502, now has the polarization orientation which is reflected by polarization-sensitive mirror, 520. The light is then reflected from mirror 503, passed back through polarization rotator 510a, and recovers its original polarization, 504. In the bottom half of FIG. 5a, polarization rotator 510b is set to have no effect. Thus the light passing through the rotator retains the original polarization, and also passes through the switchable mirror (505-506-507). The overall effect of the switchable mirror assembly in FIG. 5a therefore is to either transmit or reflect the incident polarized light, depending on how polarization rotator 510 is set, while leaving the polarization of the light exiting the device unchanged.

FIG. 5b shows how an adjustable lag interferometer, according to the present invention, may be constructed using the switchable mirror selectively enabled delay assembly described above. Unpolarized input light, 550, is polarized in the plane of the figure by input polarizer 551. The light is then split by beamsplitter 552 into two beams, 553 and 554. One beam, 553, reflects off of fixed mirror 555, and a portion passes back through the beamsplitter, forming part of the output beam 590. The other beam, 554, first traverses an (optional) variable retarder 560, and then enters a stack of switchable mirror assemblies 575. The light is then reflected from the first mirror assembly that is ‘turned on’. A portion of the returning light then reflects from beamsplitter 552, and enters the output beam with some relative lag, 591. The total output beam then interferes at and is measured by output detector 595, whose readings are preferably recorded by computer 599.

The interferometer in FIG. 5b thus switches, with no moving parts, between a set of fixed lags, depending on which mirror assembly is turned on. If it is desired that the interferometer be able to address lags between the fixed set defined by the dimensions of the switchable mirror stack, then some small adjustable delay element can be included. An example is adjustable retarder 560 shown in the figure. Other means could move the ‘fixed’ mirror by a small amount. Regardless of the method employed, only small adjustments in the lag are necessary, so that the device may be relatively inexpensive and mechanical stable. The total lag range addressed by the interferometer, however, is limited only by the number of switchable mirror assemblies included in switchable mirror stack 575. Thus this interferometer can address an indefinitely large lag range, while retaining the stability and cost effectiveness of an interferometer designed for only a small lag range.

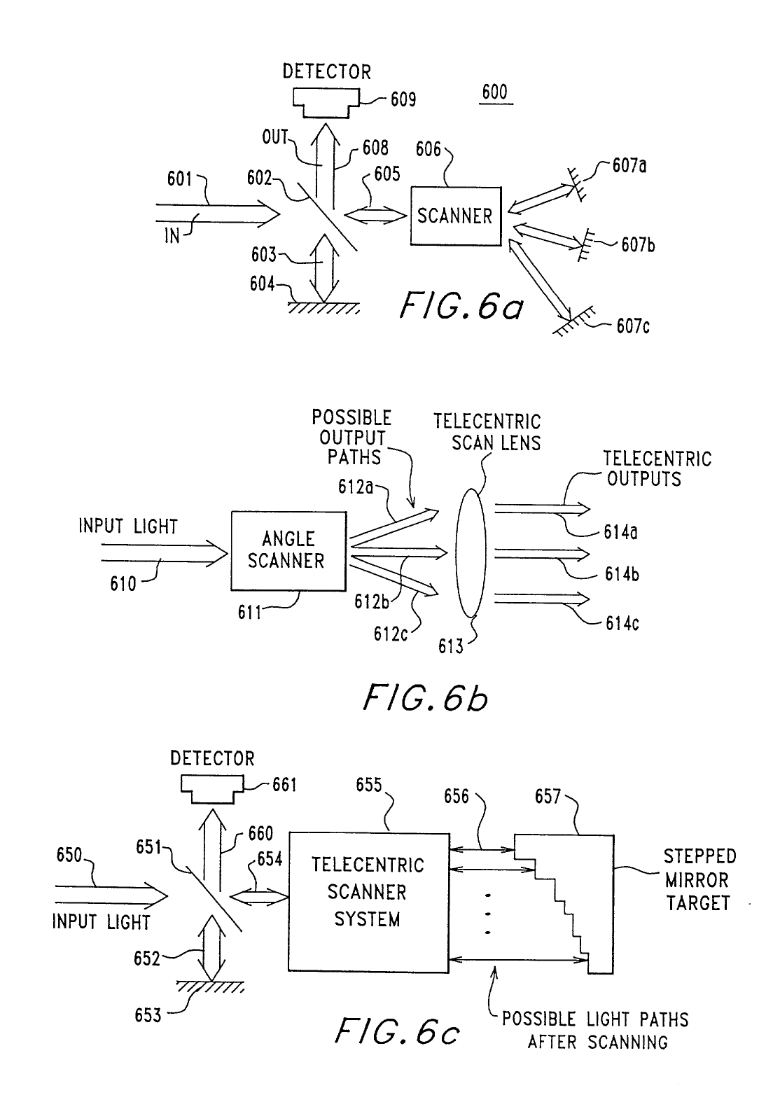

FIG. 6a shows how light may be switched between a plurality of different length delay elements using a generic beam-scanner. The input light to interferometer 601, is divided by beamsplitter 602. One part of the light, 603, is reflected from fixed mirror 604, and returns through the beamsplitter to enter output beam 608. The other part of the input light, 605, is directed by scanner 606, to one of a multiple number of fixed mirrors, 607a-c, each defining a different delay. After reflection from one of these mirrors, the light returns through scanner 606 (where it is de-scanned—that is, returned to the original axis that it entered on), reflects off of beamsplitter 602, and joins the other part of the light as it enters output beam 608. The intensity of output beam 608 is then read by detector 609, and the result is stored. The output intensity as a function of which of the several paths 607 the light followed constitute discrete samples of the interferogram. The advantage of the interferometer shown in FIG. 6a is that the scanner only has to be accurate enough to select between the different delays imparted by the different paths—the accuracy and stability of the light paths themselves can be much greater than the intrinsic accuracy and stability of the scanner. This is particularly true if, instead of mirrors 607, means of retro-reflection, such as corner cubes, are used. A corner-cube, for example, has the property that the light always is reflected back exactly the way it came from, thus requiring the scanner only to be accurate enough to hit the cube. Beam scanners are a stock commercial item, and can be based on galvanometer-driven mirrors, acousto-optic cells, or rotating mirrors.

Beam-scanning devices are commercially available items. Scanners are available which can scan over a two-dimensional area at up to video rates and resolutions: 30 to 60 complete scans per second, with a total number of “addressable” points of 200,000 to 1 million. FIG. 6b shows a typical scan arrangement whereby a one or two dimensional angle scan is converted into a one or two dimensional telecentric area scan: Input light 610 enters the scanner and is directed to one of the plurality of output paths, three of which are shown: 612a, b, and c. Each light path imparts a different delay on light directed to it. The scanned light enters telecentric scan lens 613, where it is changed to a beam of light parallel to the system axis (the meaning of telecentric). This lens is shown schematically as a single lens; but in fact it would almost certainly be a compound combination of lenses.

FIG. 6c shows how a telecentric scanner system can be used to implement a fast and stable interferometer. Input light 650 is divided by beamsplitter 651. One part of the divided light, 652, reflects from fixed mirror 653. A portion of the reflected light passes back through beamsplitter 651 and joins output beam 660. The other part of the light, 654, passes into telecentric scanner system 655, and is directed to one of a plurality of mirrored facets on stepped-mirror target 657. Each facet defines a different delay for the reflected light. After reflection from one of the facets, light 656, re-enters scanner 655, is de-scanned (normal optical systems work the same in both directions), and exits along original input path 654. A portion of such light then reflects off of beamsplitter 651 and joins output beam 660, which proceeds to detector 661. The intensity seen by the detector, as a function of the selected delay differences between the two paths 652 and 654, is the interferogram, from which the input light spectrum can be obtained.

The interferometer in FIG. 6c has a number of remarkable properties:

It can scan a large number of lags very quickly: A video-style 2-D scanner, for example can address about 500 points on each of 480 lines, or 240,000 different possible lags, in 1/30 second.

The accuracy of the lags generated does not depend on the accuracy of the scanner. The delay difference due to reflection from any of the target's facets is fixed by the position of the static target, 657, and the fixed mirror, 653. Since neither of these need to move, they can easily be made very stable. The accuracy of the scanner merely determines how many facets can be reliably addressed. Most spectrographic applications of an interferometer need less than 20,000 samples of the interferogram. A commercial video-scanner can typically address 240,000 or so points, more than 10 times the accuracy required in this application.

The stepped-mirror target can be cheaply replicated from a master unit by molding techniques, much as replica diffraction gratings are now made.

The net result of these characteristics is an interferometer which can scan very fast with a very high degree of accuracy and repeatability, while being constructed from stock items of moderate precision and cost.

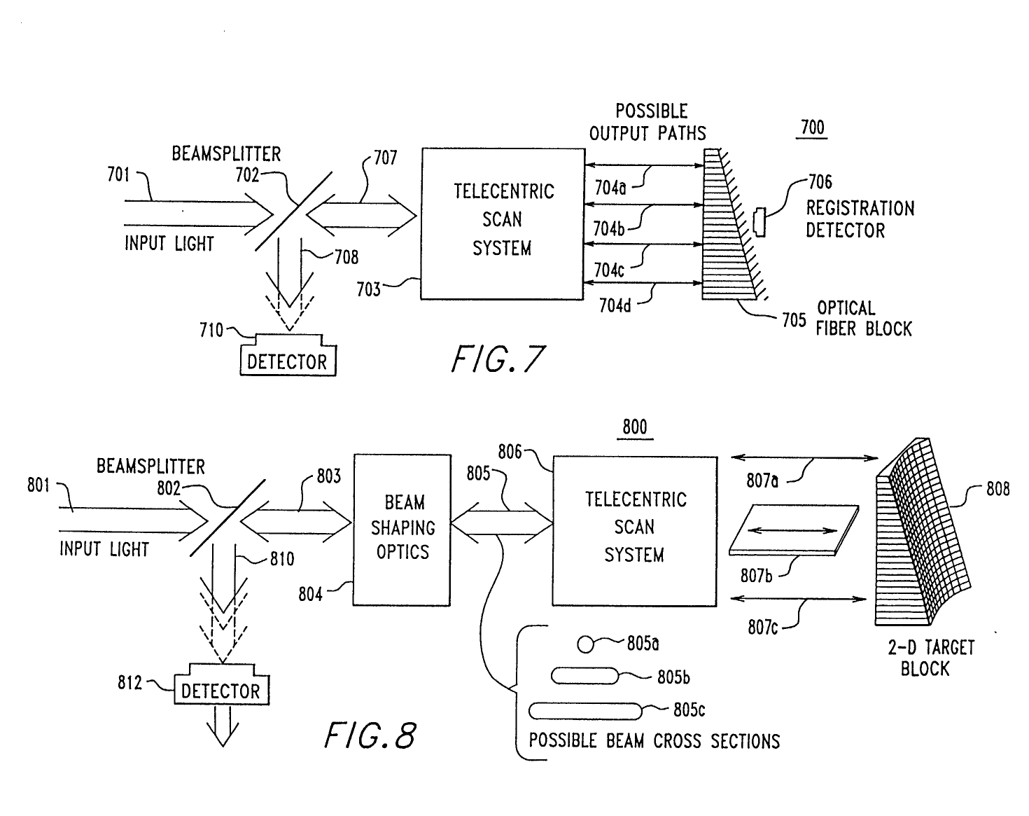

FIG. 7 shows a further embodiment of the scanner-based interferometer—In this case, the beam-scanning means are used to switch between a plurality of optical selectively enabled delay differences, rather than just path lengths. As before, input light 701 passes into telecentric scan system 703, where it is switched between a plurality of possible output paths, 704a, b, . . . In this embodiment, the target is a block, or plate, of optical fibers, 705. This block has been ground, polished, etched, or otherwise treated, so that the length of the fibers varies from place to place on the block. It has been further treated so that light impinging on its face produces two equal reflections: The first reflection comes directly off of the end of the fiber facing the scanner; the second reflection is from light which first enters the fiber, then reflects from the far end of said fiber, and finally emerges from the face of the fiber back towards the scanner. The double reflections from fiber block 705 then proceed back through scanner 703; they are de-scanned and returned to original input path 707, sampled by beamsplitter 702, and hence proceed to detector 710.

Note that the light in output beam 708 consists of a portion of the input light plus a delayed copy of that light—the amount of lag being a function only of where on the fiber block the beam reflected, and not affected by any other alignment or position of anything in the system.

Since only the pointing accuracy of the scan system can affect the accuracy of the interferometer in FIG. 7, a method of continuously calibrating the scan accuracy is feasible. A number of registration detectors are placed at known positions on the back of the fiber block. One such detector, 706, is shown in the figure. The detectors are designed to respond to light leaking from the back of a particular fiber in the block—either in the normal usage, or by modifying the treatment of the end of that fiber, if necessary. Each detector signals when the scan has reached the fiber that it monitors, thus providing a means of continuously calibrating the scanner.

The interferometer in FIG. 7 shares all of the advantageous characteristics of the interferometer described in FIG. 6c—speed, accuracy, and number of lags sampled—plus the following unique benefits:

The lag values are fixed by the physical characteristics of the target block—they are completely independent of any properties of the other optics or alignments in the system.

The pointing accuracy of the scan system is continually being re-calibrated—thus the interferometer can never go out of calibration.

FIG. 8 shows an interferometer like that shown in FIG. 7, with the addition of beam-shaping optics, 804, which are capable of adjustably controlling the width of the beam, as shown by the possible beam cross-sections achievable, 805a, b, and c, and special target block 808. Input light 801 passes into beam shaping optics 804, where it is either left as a circular beam 805a or the width of the beam is adjusted to one of several values: 805b, 805c. The beam then enters telecentric scan system 806, and reflects from some portion of target block 808. There are two modes of operation of the device:

Interferometer mode: The beam is kept circular (as shown by 805a) and is scanned along one or more columns of target block 808, thus producing a linear progression of lags at output detector 812. The interferogram thus produced can be used in the normal fashion to generate the spectrum of the input light.

Tunable Filter mode: The beam is widened (as shown in 805b or 805c) by beam-shaping optics 804. The beam then reflects from all or a portion of a row of fibers in target block 808. The reflected beam thus contains a multiplicity of lagged copies, as shown by the multiple arrows in output 810. The target block is constructed so that the lags from a row create the effect of a bandpass filter. The target block is designed such that the bandpass width of the filter becomes narrower as more of the row is included (i.e., as the beam width is made wider), and the center wavelength of the bandpass filter shifts as the beam is moved up or down the block to other rows.

Thus, the device shown in FIG. 8 can function both as a fast, stable, high-resolution interferometer (with all of the lags in the target block addressable); or as a variable-width, tunable, band-pass filter.

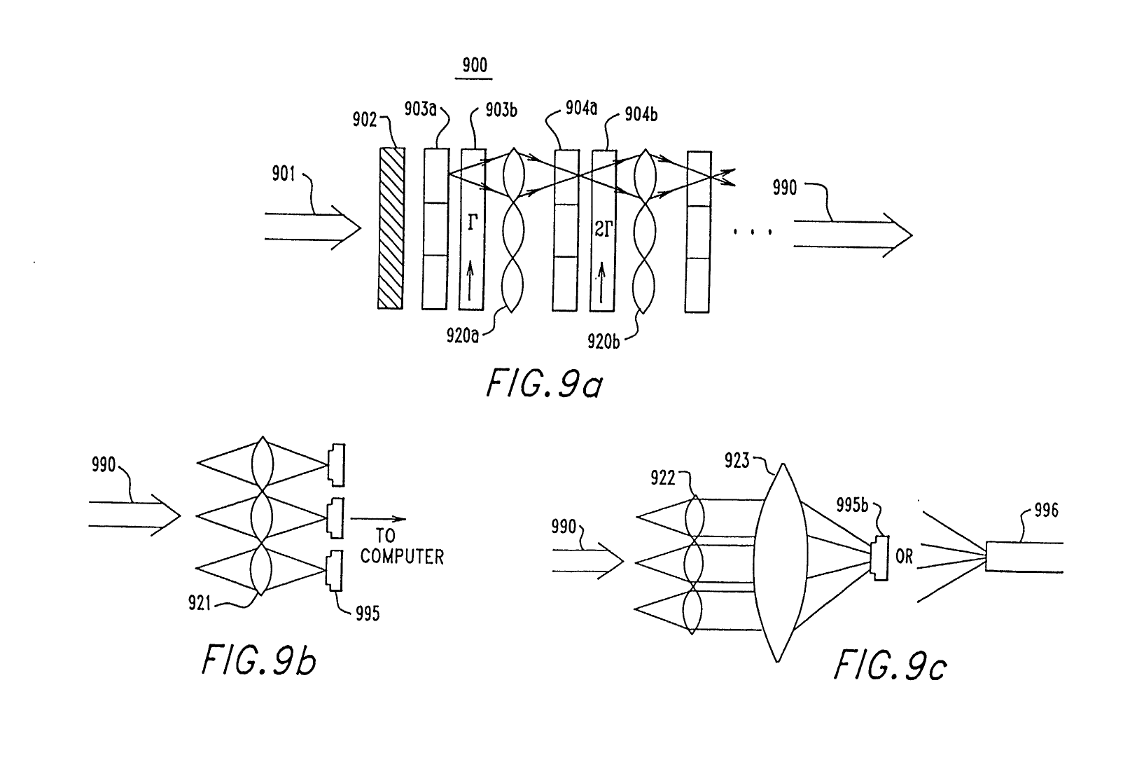

The adjustable lag interferometer shown in FIG. 9a implements many parallel paths at once, each of which incorporates independent selectively enabled delay elements. Input light 901 is distributed over spatial light modulator (SLM) 903a. The input light can be either polarized vertically by polarizer 902, as shown by the arrows associated with each ray in the figure, or can be polarized at 45° to vertical, in which case it can be considered to have both a vertical and horizontal component. Which choice is made depends on whether the device is used as a common-path interferometer or a separated-path interferometer. SLM 903a, which may be a liquid-crystal array of separately-addressable pixels, performs the task of either rotating or not rotating the polarization of the light that passes through each pixel. After passing through SLM 903a, the light then passes through a first plate of birefringent material, 903b, of thickness L, the optic axis of which is oriented, for example, vertically. The optical delay through plate 903b for the vertically-polarized portion of the light is nₑL; where nₑ is the extra-ordinary index of refraction of the plate. For the horizontally polarized portion of the light, the optical delay through plate 903 is nₒL, where nₒ is the ordinary index of refraction of the plate.

After traversing the first SLM/retarder plate combination 903, the rays are focussed by microlens array 920 onto the next stage 904. Microlens array 920 could be replaced by a conventional lens, but this device would be larger. Stage 904 comprises SLM 904a and retarder plate 904b of thickness 2L, microlens array 920b, etc. The output rays 990 are detected as shown in FIGS. 9b and 9c.

FIG. 9b shows the detection scheme for a muliple path interferometer. Rays 990 are focussed through a microlens array 921 and detected by an array of light-sensitive detectors, 995a, which may be implemented by a CCD array, for example.

Thus, each separate path through the interferometer (of which two are shown, 901a and 901b) is equivalent to a complete adjustable lag interferometer, such as is shown in FIG. 2. While the arrangement shown in FIG. 9a will work only with collimated light, it will be evident to one skilled in the optical arts that optical relays made of lenses, lenslet arrays, or fiber-optic blocks—or some combination thereof—can be used between SLM/retarder combinations so as to image each SLM onto the next, thus allowing the device to be used with light that enters the device at a wide range of angles.

This device may be used as a programmable, spatial-output interferometer, where the degree of parallelism in producing the interferogram can be user-controlled simply by driving blocks of pixels with the same signal.

FIG. 9c shows the detector scheme used to implement a FIR filter (with each parallel path in FIG. 9a implementing a separate delay). Microlens array 921 focusses rays 990 onto a lens 923, thus combining all of the parallel rays at detector 995b (or fiber 996).

Since the device of FIG. 9a can be used to put an arbitrary delay on any portion of the light that enters, it can be used to implement other tasks. For example, it can be used to produce a high-order (many wavelengths of delay) grating structure. This kind of structure can be used to selectively separate wavelengths of light with high resolution. A programmable structure can be used as a tunable wavelength filter or wavelength switch.

The structure can be used to correct distorted input wavefronts by selectively adjusting the delay on each portion so as to produce a flat wavefront from the distorted one. In other words, this device can function as an adaptive-optics wavefront corrector. This has applications in correcting distorted images that are seen through atmospheric turbulence, or in measuring distorted or errors produced by other optical elements such as lenses and mirrors.

1. An adjustable lag interferometer of the type including means for separating an input beam into two paths, means for applying adjustable relative lag to light passing through the two paths, and means for recombining light from the two paths, wherein the means for applying adjustable relative lag comprises:
a plurality of selectively enabled delay elements each incorporated into one of the interferometer paths,
each delay element selectively applying a delay of either P or P+nΓ to light passing through the path in which said element is incorporated.

2. The interferometer of claim 1, wherein the delay elements selectively apply delays of Γ, 2Γ, 4Γ, . . . 2NΓ, where Γ represents the smallest change of lag desired.

3. The interferometer of claim 1, further including a variable delay element incorporated into one of the paths.

4. The interferometer of claim 1 wherein the two paths are physically separate to form a split-path interferometer.

5. The interferometer of claim 4, wherein the delay elements comprise optical fibers of diverse lengths switched into or out of one of the interferometer paths.

6. The interferometer of claim 1 wherein the two paths are physically coincident to form a common-path interferometer.

7. The interferometer of claim 6, wherein:
the means for separating the input beam into two paths separates the input beam into two beams having different polarizations; and
wherein each delay element comprises a birefringent plate and a selectively operable polarization rotator for determining the optical path length through the plate for each beam.

8. The interferometer of claim 7, wherein the polarization rotators are arranged in parallel arrays.

9. The interferometer of claim 8 wherein the polarization rotators are Liquid-Crystal Spatial Light Modulators (SLMs)

10. The interferometer of claim 8, further including an array of detectors at the output.

11. The interferometer of claim 1, wherein:
the means for separating the input beam into two paths separates the input beam into two beams having different polarizations; and
wherein each delay element comprises a switchable mirror using a polarization sensitive reflector and a selectively operable polarization rotator for determining the optical path length applied by the mirror for each beam.
